(19) United States
(12) Patent Application Publication
(10) Pub. No.: US 2025/0233239 A1
(43) Pub. Date: Jul. 17, 2025

(54) ELECTROCHEMICAL DEVICE AND ELECTRONIC DEVICE

(71) Applicant: Ningde Amperex Technology Limited, Ningde (CN)

(72) Inventors: Qiong QU, Ningde (CN); Sen LIN, Ningde (CN); Xingfang ZHENG, Ningde (CN); Le WANG, Ningde (CN)

(73) Assignee: Ningde Amperex Technology Limited, Ningde (CN)

(21) Appl. No.: 19/026,767

(22) Filed: Jan. 17, 2025

(30) Foreign Application Priority Data
Jan. 17, 2024 (CN) 202410070406.0

(51) Int. Cl. H01M 50/186; H01M 50/105; H01M 50/136; H01M 50/184

(52) U.S. Cl. CPC H01M 50/186; H01M 50/105; H01M 50/136; H01M 50/184

(57) ABSTRACT

An electrochemical device includes an electrode assembly, a packaging shell, and an adhesive component. The packaging shell includes a main portion and a seal edge portion. The electrode assembly is disposed in the main portion. The seal edge portion includes a first section and a second section that are folded. The second section includes a first end and a second end. The first section connects the main portion and the first end. The second end is disposed between the first section and a lateral edge of the main portion. The adhesive component is adhered between the lateral edge of the main portion and the second section. The second section is connected to the adhesive component. Along a thickness direction of the electrode assembly, an end of the adhesive component extends beyond the second end of the second section, and the adhesive component wraps the second end.

### CROSS-REFERENCE TO RELATED APPLICATION

This application claims priority to Chinese patent application 202410070406.0, filed on Jan. 17, 2024, the contents of which are incorporated herein by reference in its entirety.

### TECHNICAL FIELD

This application relates to the field of battery technology, and in particular, to an electrochemical device and an electronic device.

### BACKGROUND

In a packaging structure of a pouch cell, in order to prevent the battery cell from corrosion or short-circuiting with the external environment, a seal edge structure of a packaging shell needs to be trimmed and folded to wrap the internal battery cell structure, reduce the width of the battery, and increase the energy density of the battery. However, when the battery is dropped or subjected to impact, the folded edge structure is prone to puncture the packaging shell, result in damage and failure of the battery, and pose safety hazards.

### SUMMARY

This application provides an electrochemical device and an electronic device to solve the above technical problems.

Some embodiments of this application are implemented in the following way:

An electrochemical device is disclosed, including an electrode assembly, a packaging shell, and an adhesive component. The packaging shell includes a main portion and a seal edge portion. The electrode assembly is disposed in the main portion. The seal edge portion is located at a lateral edge of the main portion. The seal edge portion includes a first section and a second section that are folded. The second section includes a first end and a second end. The first section connects the main portion and the first end. The second end is disposed between the first section and a lateral edge of the main portion. The adhesive component is adhered between the lateral edge of the main portion and the second section. The second section is connected to the adhesive component. Along a thickness direction of the electrode assembly, an end of the adhesive component extends beyond the second end, and the adhesive component wraps the second end. In this way, the adhesive component can seal the second end, and at the same time, avoid direct contact between the second end and the lateral edge of the main portion. Therefore, when the electrochemical device is dropped or subjected to impact, the adhesive component can bear and buffer an impact force of the second end on the main portion, thereby reducing the risk of damage to the packaging shell and improving the safety performance of the electrochemical device.

In a possible embodiment, along the thickness direction of the electrode assembly, a bonding length of the adhesive component on a side, oriented away from the first section, of the second section is L1, and a length of the second section is L2, satisfying: 0.5 mm≤L1≤L2, so as to ensure that the adhesive component is of sufficient bonding strength, prevent the upper end of the adhesive component from exceeding the upper end of the seal edge portion, reduce the adverse effect on the energy density, and improve the aesthetic appearance of the battery cell.

In a possible embodiment, the lateral edge of the main portion includes a first curved surface and a second curved surface. The first curved surface is connected between the first section and the second curved surface. A junction between the first curved surface and the second curved surface is a vertex of the lateral edge of the main portion. The vertex is a widest position of the main portion. An accommodation space is provided between the first curved surface and the first section. The adhesive component is partially disposed in the accommodation space. The accommodation space includes a swollen portion. Along a width direction of the electrode assembly, a width of the swollen portion is a maximum width of the accommodation space. A projection of the swollen portion on the first curved surface does not coincide with the vertex. In this way, the width of the swollen portion and the maximum width of the electrode assembly are prevented from being stacked cumulatively, thereby reducing the overall width of the electrochemical device, reasonably utilizing the space in the curved surface region of the side plate of the main portion, and increasing the energy density.

In a possible embodiment, the second end is located on one side of the second curved surface, and a projection of the second end on the second curved surface does not coincide with the vertex. In this way, the second section and the maximum width of the electrode assembly are prevented from being stacked cumulatively, thereby further reducing the overall width of the electrochemical device, and increasing the energy density.

In a possible embodiment, both the first section and the second section are located on one side of the first curved surface, and a projection of the first end on the first curved surface does not coincide with the vertex. In this way, the seal edge portion as a whole is prevented from exceeding the vertex. The entire seal edge portion is disposed inside the region of the lateral edge of the first curved surface, thereby reducing the adverse effect of the seal edge portion on the overall width of the electrochemical device, and in turn, increasing the energy density.

In a possible embodiment, the adhesive component includes a heap portion. Along the width direction of the electrode assembly, the heap portion is a thickest position of the adhesive component. A projection of the heap portion on the lateral edge of the main portion does not coincide with the vertex, thereby avoiding cumulative stacking of the maximum thickness of the adhesive component and the maximum thickness of the electrode assembly.

In a possible embodiment, the adhesive component is partially disposed between the first section and the second section. A cavity is provided between the second section and the first section. Along the thickness direction of the electrode assembly, a bonding length of the adhesive component on a side, close to the first section, of the second section is L3, satisfying: L3≥0.2 mm, thereby ensuring that the adhesive component sufficiently wraps the second end, and reducing the probability that the second end is cracked or pierces the packaging shell.

In a possible embodiment, along the thickness direction of the electrode assembly, a length of the second section is L2, and a bonding length of the adhesive component on a side, close to the first section, of the second section is L3, satisfying: L2−L3≥0.3 mm, so that a cavity is formed between the upper end of the second section and the upper end of the first section to play a buffering role.

In a possible embodiment, an accommodation space is defined between the first section, the second end, and the lateral edge of the main portion. Along the thickness direction of the electrode assembly, a length of the adhesive component inside the accommodation space is L4, and a length of the accommodation space is L5, satisfying: L4≤L5. When L4 is less than L5, a space can also be formed at the bottom of the accommodation space to play a buffering role. When L4 is equal to L5, the accommodation space can be filled with the adhesive component, thereby improving the impact resistance of the seal edge portion.

In a possible embodiment, L5−L4≥0.2 mm.

In a possible embodiment, along a width direction of the electrode assembly, between the lateral edge of the main portion and the second section, a thickness of the adhesive component is less than a thickness of the second section, and the thickness of the adhesive component is less than or equal to 90 microns, thereby ensuring that the adhesive component can sufficiently wrap the second end, and reducing the adverse effect of the adhesive component on the overall size of the electrochemical device.

In a possible embodiment, the main portion further includes a first plane, a second plane, and a third curved surface. The first plane is opposite to the second plane. The first plane is connected to the lateral edge. The second plane is connected to the third curved surface. The lateral edge and the third curved surface are both connected to the first section.

Further, a clearance space is formed between the third curved surface and the electrode assembly. The clearance space is configured to buffer the impact force received by the electrochemical device. The third curved surface can form a buffer space between the packaging shell and the electrode assembly on the one hand, and can make the packaging shell more aesthetically pleasing on the other hand, and alleviate the stress concentration problem in a case of right-angle connection.

In a possible embodiment, along the thickness direction of the electrode assembly, a distance from a junction between the third curved surface and the first section to the second plane is F, satisfying: F<0.1 mm.

An embodiment of this application further provides an electronic device. The electronic device includes an electrical component and the electrochemical device disclosed in the above embodiment. The electrical component is electrically connected to the electrochemical device.

### BRIEF DESCRIPTION OF DRAWINGS

To describe technical solutions in embodiments of this application more clearly, the following outlines the drawings to be used in the embodiments. Understandably, the following drawings show merely some embodiments of this application, and therefore, are not intended to limit the scope. A person of ordinary skill in the art may derive other related drawings from the drawings without making any creative efforts.

FIG. 1 is a cross-sectional schematic view of an electrochemical device according to an embodiment of this application;

FIG. 2 is a cross-sectional schematic view of an electrochemical device according to another embodiment;

FIG. 3 is a cross-sectional schematic view of an electrochemical device according to another embodiment;

FIG. 4 is a cross-sectional schematic view of an electrochemical device according to another embodiment;

FIG. 5 is a cross-sectional schematic view of an electrochemical device according to another embodiment; and

FIG. 6 is a simplified structural diagram of an electronic device according to an embodiment.

### LIST OF REFERENCE NUMERALS

electrochemical device 100
electrode assembly 10
packaging shell 20
body portion 21
first curved surface 211
second curved surface 212
vertex P
first plane 213
second plane 214
third curved surface 215
seal edge portion 22
first section 23
second section 24
first end 241
second end 242
adhesive component 30
heap portion 31
accommodation space 40
swollen portion 41
clearance space 50
electronic device 200
electrical component 201

### DETAILED DESCRIPTION

The following clearly and thoroughly describes the technical solutions in some embodiments of this application with reference to the drawings hereto. Evidently, the described embodiments are merely a part of but not all of the embodiments of this application.

It is hereby noted that a component referred to as being “fixed to” another component may be directly fixed onto the other component or may be fixed onto the other component through an intermediate component. A component considered to be “connected to” another component may be directly connected to the other component or may be connected to the other component through an intermediate component. A component considered to be “disposed on” another component may be directly disposed on the other component or may be disposed on the other component through an intermediate component. The terms “vertical”, “horizontal”, “left”, “right” and similar expressions used herein are merely for ease of description.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein is intended to include any and all combinations of one or more relevant items recited.

The following describes some embodiments of this application in detail. To the extent that no conflict occurs, the following embodiments and the features in the embodiments may be combined with each other.

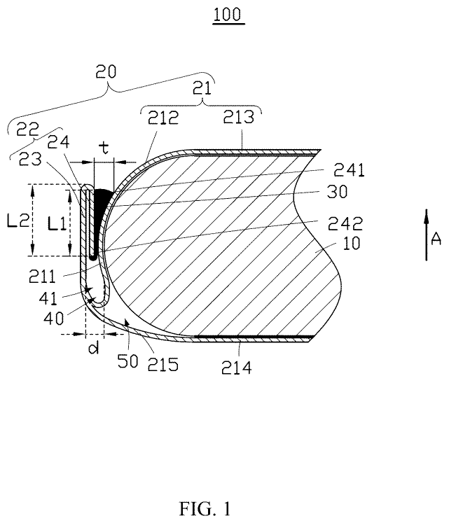

Referring to FIG. 1, an embodiment of this application provides an electrochemical device 100, including an electrode assembly 10, a packaging shell 20, and an adhesive component 30. The packaging shell 20 includes a main portion 21 and a seal edge portion 22. The electrode assembly 10 is disposed in the main portion 21. The seal edge portion 22 is located at a lateral edge of the main portion 21. The seal edge portion 22 includes a first section 23 and a second section 24 that are folded. The second section 24 includes a first end 241 and a second end 242. The first section 23 connects the main portion 21 and the first end 241. The second end 242 is disposed between the first section 23 and a lateral edge of the main portion 21. The adhesive component 30 is adhered between the lateral edge of the main portion 21 and the second section 24. The second section 24 is connected to the adhesive component 30. Along a thickness direction of the electrode assembly 10, an end of the adhesive component 30 extends beyond the second end 242 of the second section 24, and the adhesive component 30 wraps the second end 242. In this way, the adhesive component 30 can seal the second end 242, and at the same time, avoid direct contact between the second end 242 and the lateral edge of the main portion 21. Therefore, when the electrochemical device 100 is dropped or subjected to impact, the adhesive component 30 can bear and buffer an impact force of the second end 242 on the main portion 21, thereby reducing the risk of damage to the packaging shell 20 and improving the safety performance of the electrochemical device 100.

Specifically, in an embodiment of this application, during manufacture of the electrochemical device 100, the electrode assembly 10 is put into the packaging shell 20 first, and then the lateral edges of the packaging shell 20 are trimmed and pressed to form a main portion 21 and a seal edge portion 22 of the packaging shell 20. The electrode assembly 10 is accommodated in the internal space of the main portion 21. Next, the trimmed lateral edge structure of the packaging shell 20 is folded at least twice so that the seal edge portion 22 is tucked to the lateral edge of the main portion 21, thereby forming a first section 23 and a second section 24 that are stacked up. The bent seal edge portion 22 not only reduces the width of the electrochemical device 100, but also improves the hermeticity of the seal edge portion 22. Before the second section 24 is tucked to the lateral edge of the main portion 21, the adhesive component 30 is adhered to the lateral edge of the main portion 21. The seal edge portion 22 is bent toward the main portion 21. In this way, when the second section 24 is tucked to the lateral edge of the main portion 21, the second section 24 can contact the adhesive component 30. In addition, the adhesive component 30 wraps the second end 242 of the second section 24, so that the adhesive component 30 hermetically seals the nick of the seal edge portion 22.

Further, along the thickness direction of the electrode assembly 10, that is, along the direction indicated by the arrow A in FIG. 1, the bonding length of the adhesive component 30 on a side, oriented away from the first section 23, of the second section 24 is L1, and the length of the second section 24 is L2, satisfying: 0.5 mm≤L1≤L2. Neither L1 nor L2 is less than 0.5 mm, thereby ensuring that a sufficient bonding length and a sufficient bonding area are provided between the adhesive component 30 and the second section 24, achieving sufficient bonding strength of the adhesive component 30, and preventing the problem of unexpected cracking. L1 being not less than L2 prevents the upper end of the adhesive component 30 from exceeding the upper end of the seal edge portion 22, reduces the adverse effect on the energy density, alleviates the overflow of adhesive, and reduces the amount of adhesive to be used.

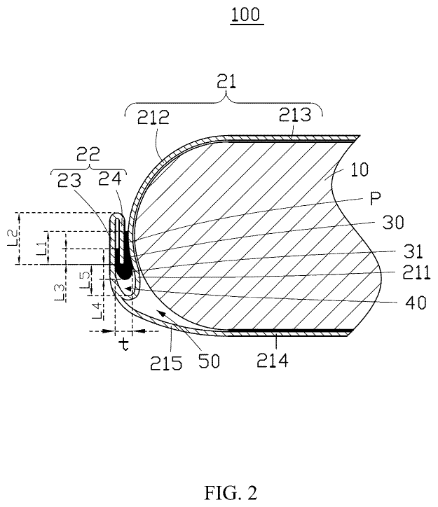

As shown in FIG. 2, in a possible embodiment, a cavity is provided between the second section 24 and the first section 23. The adhesive component 30 may be partially disposed between the first section 23 and the second section 24, so that the first section 23 can also be fixed to the second section 24 by the adhesive component 30, thereby preventing the seal edge portion 22 from bulging, deforming, and other problems caused by elastic deformation of the seal edge portion, and improving the structural compactness of the seal edge portion 22. Along the thickness direction of the electrode assembly 10, a bonding length of the adhesive component 30 on a side, close to the first section 23, of the second section 24 is L3, satisfying: L3≥0.2 mm, thereby ensuring that the adhesive component 30 can sufficiently wrap the second end 242 while fixing the second section 24 and the first section 23, and in turn, reducing the probability that the second end 242 is cracked or pierces the packaging shell 20.

Further, along the thickness direction of the electrode assembly 10, the bonding length of the adhesive component 30 on a side, close to the first section 23, of the second section 24 is L3. The length L2 of the second section 24 is greater than L3, and satisfies: L2−L3≥0.3 mm. In this way, the clearance formed between the first section 23 and the second section 24 is partially filled with the adhesive component 30 only at the lower end close to the second end 242, and a cavity is formed between the upper end, close to the first end 241, of the second section 24 and the upper end of the first section 23. The cavity structure can play a buffering role when the electrochemical device 100 is dropped or subjected to impact, minimize the amount of the adhesive component 30 to be used, and avoid the problem of an increase in the overall size of the electrochemical device 100 caused by the accumulation of excessive adhesive component 30 between the first section 23 and the second section 24.

Further, an accommodation space 40 is defined between the first section 23, the second end 242, and the lateral edge of the main portion 21. Along the thickness direction of the electrode assembly 10, the length of the adhesive component 30 inside the accommodation space 40 is L4, and the length of the accommodation space 40 is L5, satisfying: L4≤L5. As shown in FIG. 2, when L4 is less than L5, a space can also be formed at the bottom of the accommodation space 40. The space serves as an air bag at the bottom of the seal edge portion 22, and can play a buffering role, thereby further improving the drop safety of the electrochemical device 100. In an embodiment, L5−L4≥0.2 mm, thereby ensuring that an air bag large enough is formed at the bottom of the accommodation space 40 to enhance the buffering effect.

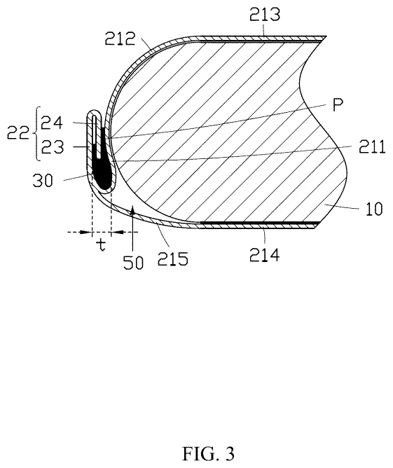

In some other embodiments, as shown in FIG. 3, when L4 is equal to L5, the accommodation space 40 can be filled with the adhesive component 30, thereby not only sufficiently wrapping the cut end of the seal edge portion 22, but also improving the mechanical strength of the seal edge portion 22, and in turn, improving the impact resistance of the seal edge portion 22.

Still referring to FIG. 1, FIG. 2, and FIG. 3, in a possible embodiment, the lateral edge of the main portion 21 includes a first curved surface 211 and a second curved surface 212. The first curved surface 211 is connected between the first section 23 and the second curved surface 212. A junction between the first curved surface 211 and the second curved surface 212 is a vertex P of the lateral edge of the main portion 21. The vertex P is a widest position of the main portion 21, and is shown as one point in the cross-sectional view in the drawing. In the three-dimensional structure of the electrochemical device 100, the most convex position may also be shown as one top edge or one section of top surface. The accommodation space 40 between the first section 23, the second end 242, and the lateral edge of the main portion 21 is located between the first curved surface 211 and the first section 23. The accommodation space 40 is roughly in the shape of a water drop-shaped pocket. Further, the accommodation space 40 includes a swollen portion 41. Along the width direction of the electrode assembly 10, the width d of the swollen portion 41 is the maximum width of the accommodation space 40. A projection of the swollen portion 41 on the first curved surface 211 does not coincide with the vertex P of the lateral edge of the main portion 21. In an embodiment of this application, the seal edge portion 22 extends out from the lower side of the main portion 21 and is bent, and the swollen portion 41 of the accommodation space 40 is located below the vertex P. In some other embodiments of this application, the seal edge portion 22 may extend out from the lower side of the main portion 21 and be bent, and the swollen portion 41 of the accommodation space 40 is located above the vertex P. In this way, the width of the swollen portion 41 and the maximum width of the electrode assembly 10 are prevented from being stacked cumulatively, thereby reducing the overall width of the electrochemical device 100, reasonably utilizing the space in the curved surface region of the side plate of the main portion 21, and increasing the energy density.

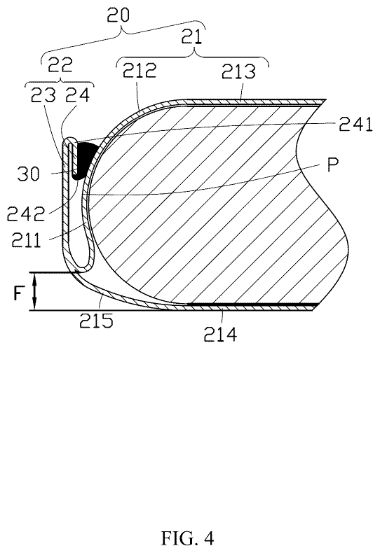

In another embodiment, the second end 242 of the second section 24 is located on one side of the second curved surface 212, and a projection of the second end 242 on the second curved surface 212 does not coincide with the vertex P. Specifically, as shown in FIG. 4, along the thickness direction of the electrode assembly 10, when the upper end of the first section 23 exceeds the vertex P, the length of the second section 24 may be shortened, so that the second section 24 is entirely located outside the second curved surface 212, and in turn, the second end 242 of the second section 24 is located above the vertex P. In this way, the adhesive component 30 may be disposed outside the second curved surface 212 instead. Both the second section 24 and the adhesive component 30 are arranged in the space outside the second curved surface 212, thereby preventing the second section 24 and the widest position of the electrode assembly 10 from being stacked up, reducing the distance between the first section 23 and the lateral edge of the main portion 21, reducing the overall width of the electrochemical device 100, and increasing the energy density.

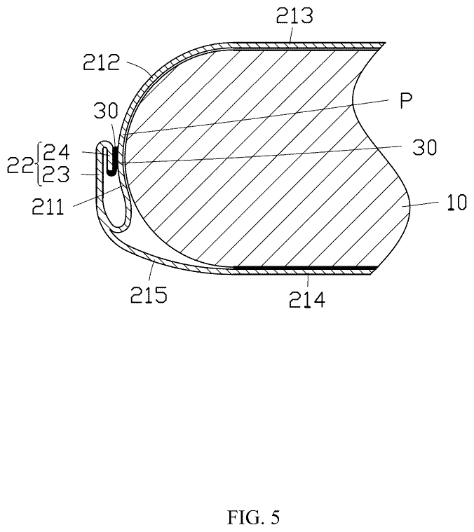

In another embodiment, both the first section 23 and the second section 24 are located on one side of the first curved surface 211, and a projection of the first end 241 of the second section 24 on the first curved surface 211 does not coincide with the vertex P. Specifically, as shown in FIG. 5, the overall size of the seal edge portion 22 is reduced. Along the thickness direction of the electrode assembly 10, the upper end of the seal edge portion 22 does not exceed the position of the vertex P, and preferably, is located below the vertex P. In this way, both the first section 23 and the second section 24 are located on the lateral edge of the first curved surface 211, and neither the first section 23 nor the second section 24 is higher than the position of the vertex P. The adhesive component 30 may bond the seal edge portion 22 from outside the first curved surface 211. In this way, the seal edge portion 22 as a whole is prevented from exceeding the vertex P. The entire seal edge portion 22 is disposed inside the region of the lateral edge of the first curved surface 211, thereby reasonably utilizing the free space outside the curved surface. The width of the seal edge portion 22 can be controlled within the spacing between the vertex P and the lower end of the first curved surface 211, thereby reducing the adverse effect of the seal edge portion 22 on the overall width of the electrochemical device 100, and in turn, increasing the energy density.

In an embodiment, the adhesive component 30 includes a heap portion 31. Along the width direction of the electrode assembly 10, the thickness t of the heap portion 31 is the maximum thickness of the adhesive component 30. Along the thickness direction of the electrode assembly 10, the heap portion 31 is spaced apart from the vertex P, thereby avoiding cumulative stacking of the maximum thickness of the adhesive component 30 and the maximum thickness of the electrode assembly 10. Specifically, as shown in FIG. 1, the heap portion 31 of the adhesive component 30 is located between the second curved surface 212 and the second section 24, and is located above the vertex P. In this way, the thickest part of the adhesive component 30 fills the space between the second curved surface 212 and the second section 24, without being accumulated between the second section 24 and the vertex P, thereby reducing the overall width of the electrochemical device 100 and increasing the energy density. In the embodiment shown in FIG. 2 or FIG. 3, the heap portion 31 of the adhesive component 30 is located in the accommodation space 40 and below the vertex P. In this way, the thickest part of the adhesive component 30 is located between the first curved surface 211 and the first section 23, without being excessively accumulated between the vertex P and the second section 24, thereby increasing the energy density of the electrochemical device 100.

In a possible embodiment, in any example shown in FIG. 1 to FIG. 5, along a width direction of the electrode assembly 10, between the lateral edge of the main portion 21 and the second section 24, a thickness of the adhesive component 30 is at least partially less than a thickness of the second section 24, and the thickness of the adhesive component 30 is less than or equal to 90 microns, thereby ensuring that the adhesive component 30 can sufficiently wrap the second end 242, and reducing the adverse effect of the adhesive component 30 on the overall size of the electrochemical device 100.

In a possible embodiment, in any example shown in FIG. 1 to FIG. 5, the main portion 21 further includes a first plane 213, a second plane 214, and a third curved surface 215. The first plane 213 is opposite to the second plane 214. The first plane 213 is connected to the lateral edge. The second plane 214 is connected to the third curved surface 215. The lateral edge of the main portion 21 and the third curved surface 215 are both connected to the first section 23. In this way, the connection structure between the lower end of the seal edge portion 22 and the main portion 21 forms an arc structure. Compared with a right-angle connection structure, the arc connection structure is more aesthetically pleasing in appearance, and reduces stress concentration, thereby further improving the drop safety of the electrochemical device 100.

Further, a clearance space 50 is formed between the third curved surface 215 and the electrode assembly 10. The clearance space 50 is configured to buffer the impact force received by the electrochemical device 100. The clearance space 50 may be filled with an electrolyte solution to further improve the impact resistance of the clearance space 50.

In some embodiments, as shown in FIG. 4, along the thickness direction of the electrode assembly 10, a distance from a junction between the third curved surface 215 and the first section 23 to the second plane 214 is F, satisfying: F<0.1 mm. This design reduces the height of the entire seal edge portion 22, makes the seal edge portion 22 closer to the bottom surface of the main portion 21, and prevents the seal edge portion 22 from protruding beyond the upper surface of the main portion 21 to increase the thickness of the electrochemical device 100 after completion of folding the edge in an application scenario in which the edge of a thin cell is folded. This design also makes it convenient to allocate the space for different parts of the seal edge portion 22, and reduces the overall width of the electrochemical device 100.

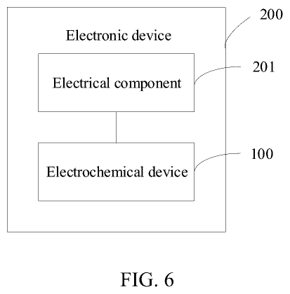

Referring to FIG. 6, an embodiment of this application further provides an electronic device 200. The electronic device includes an electrical component 201 and the electrochemical device 100 disclosed in any one of or any combination of the above embodiments. The electrochemical device 100 is electrically connected to the electrical component 201 to provide electrical energy for the electrical component 201.

The foregoing embodiments are merely intended for describing the technical solutions of this application but not intended as a limitation. Although this application is described in detail with reference to the foregoing exemplary embodiments, a person of ordinary skill in the art understands that modifications or equivalent substitutions may be made to the technical solutions of this application without departing from the spirit and scope of the technical solutions of this application.

What is claimed is:

1. An electrochemical device, comprising:
an electrode assembly;
a packaging shell, wherein the packaging shell comprises a main portion and a seal edge portion, the electrode assembly is disposed in the main portion, the seal edge portion is located at a lateral edge of the main portion, the seal edge portion comprises a first section and a second section that are folded, the second section comprises a first end and a second end, the first section connects the main portion and the first end, and the second end is disposed between the first section and the lateral edge of the main portion; and
an adhesive component, adhered between the lateral edge of the main portion and the second section, wherein the second section is connected to the adhesive component; and, along a thickness direction of the electrode assembly, an end of the adhesive component extends beyond the second end, and the adhesive component wraps the second end.

2. The electrochemical device according to claim 1, wherein
the lateral edge of the main portion comprises a first curved surface and a second curved surface, the first curved surface is connected between the first section and the second curved surface, a junction between the first curved surface and the second curved surface is a vertex of the lateral edge of the main portion, and the vertex is a widest position of the main portion; an accommodation space is provided between the first curved surface and the first section, and the adhesive component is partially disposed in the accommodation space; the accommodation space comprises a swollen portion; and, along a width direction of the electrode assembly, a width of the swollen portion is a maximum width of the accommodation space, and a projection of the swollen portion on the first curved surface does not coincide with the vertex.

3. The electrochemical device according to claim 2, wherein
the second end is located on one side of the second curved surface, and, along the width direction of the electrode assembly, a projection of the second end on the second curved surface does not coincide with the vertex.

4. The electrochemical device according to claim 2, wherein
both the first section and the second section are located on one side of the first curved surface, and, along the width direction of the electrode assembly, a projection of the first end on the first curved surface does not coincide with the vertex.

5. The electrochemical device according to claim 2, wherein
the adhesive component comprises a heap portion; and, along the width direction of the electrode assembly, the heap portion is a thickest position of the adhesive component, and a projection of the heap portion on the lateral edge of the main portion does not coincide with the vertex.

6. The electrochemical device according to claim 1, wherein
along the thickness direction of the electrode assembly, a bonding length of the adhesive component on a side of the second section is L1, and a length of the second section is L2, and: 0.5 mm≤L1≤L2; the side of the second section being a side oriented away from the first section.

7. The electrochemical device according to claim 1, wherein
the adhesive component is partially disposed between the first section and the second section, a cavity is provided between the second section and the first section, and, along the thickness direction of the electrode assembly, a bonding length of the adhesive component on a side of the second section facing the first section is L3, and L3≥0.2 mm.

8. The electrochemical device according to claim 7, wherein
along the thickness direction of the electrode assembly, a length of the second section is L2, and L2−L3≥0.3 mm.

9. The electrochemical device according to claim 1, wherein
an accommodation space is defined between the first section, the second end, and the lateral edge of the main portion; and, along the thickness direction of the electrode assembly, a length of the adhesive component inside the accommodation space is L4, and a length of the accommodation space is L5, and L4≤L5.

10. The electrochemical device according to claim 9, wherein L5−L4≥0.2 mm.

11. The electrochemical device according to claim 1, wherein
along a width direction of the electrode assembly, between the lateral edge of the main portion and the second section, a thickness of the adhesive component is less than a thickness of the second section, and the thickness of the adhesive component is less than or equal to 90 microns.

12. The electrochemical device according to claim 1, wherein
the main portion further comprises a first plane, a second plane, and a third curved surface; the first plane is opposite to the second plane, the first plane is connected to the lateral edge, the second plane is connected to the third curved surface, and the lateral edge and the third curved surface are both connected to the first section.

13. The electrochemical device according to claim 12, wherein
a clearance space is provided between the third curved surface and the electrode assembly.

14. The electrochemical device according to claim 12, wherein
along the thickness direction of the electrode assembly, a distance from a junction between the third curved surface and the first section to the second plane is F, and F<0.1 mm.

15. An electronic device, comprising an electrical component and the electrochemical device according to claim 1, and the electrical component is electrically connected to the electrochemical device.

16. The electronic device according to claim 15, wherein
the lateral edge of the main portion comprises a first curved surface and a second curved surface, the first curved surface is connected between the first section and the second curved surface, a junction between the first curved surface and the second curved surface is a vertex of the lateral edge of the main portion, and the vertex is a widest position of the main portion; an accommodation space is provided between the first curved surface and the first section, and the adhesive component is partially disposed in the accommodation space; the accommodation space comprises a swollen portion; and, along a width direction of the electrode assembly, a width of the swollen portion is a maximum width of the accommodation space, and a projection of the swollen portion on the first curved surface does not coincide with the vertex.

17. The electronic device according to claim 16, wherein
the second end is located on one side of the second curved surface, and, along the width direction of the electrode assembly, a projection of the second end on the second curved surface does not coincide with the vertex.

18. The electronic device according to claim 16, wherein
both the first section and the second section are located on one side of the first curved surface, and, along the width direction of the electrode assembly, a projection of the first end on the first curved surface does not coincide with the vertex.

19. The electronic device according to claim 16, wherein
the adhesive component comprises a heap portion; and, along the width direction of the electrode assembly, the heap portion is a thickest position of the adhesive component, and a projection of the heap portion on the lateral edge of the main portion does not coincide with the vertex.

20. The electronic device according to claim 15, wherein
along the thickness direction of the electrode assembly, a bonding length of the adhesive component on a side of the second section is L1, and a length of the second section is L2, and: 0.5 mm≤L1≤L2; the side of the second section being a side oriented away from the first section.
